(19) United States
(12) Patent Application Publication
(10) Pub. No.: US 2012/0173245 A1
(43) Pub. Date: Jul. 5, 2012

(54) NAVIGATION SYSTEM

(75) Inventors: Tadashi Miyahara, Tokyo (JP); Toyoaki Kitano, Tokyo (JP); Hideto Miyazaki, Tokyo (JP); Tsutomu Matsubara, Tokyo (JP); Kuniyo Ieda, Tokyo (JP); Minoru Ozaki, Tokyo (JP); Syoji Tanaka, Tokyo (JP); Takashi Nakagawa, Tokyo (JP); Tomohiro Shiino, Tokyo (JP); Wataru Yamazaki, Tokyo (JP)

(73) Assignee: Mitsubishi Electric Corporation, Tokyo (JP)

(21) Appl. No.: 13/394,577

(22) PCT Filed: Dec. 24, 2009
(86) PCT No.: PCT/JP2009/007182

§ 371 Date: Mar. 7, 2012

(51) Int. Cl. G09G 5/377; G10L 21/00; G06T 11/20; G06F 17/20; G09G 5/02

(52) U.S. Cl. 704/275; 706/11; 345/592; 345/629; 345/443; 704/E21.001

(57) ABSTRACT

A navigation system is provided which facilitates discrimination between an icon of a facility associated with a route, along which the user is expected to move from now on, and an ordinary icon. To achieve this, it includes a destination estimating unit for acquiring information about a driving history and for estimating a destination from the information about the driving history acquired; a drawing decision changing unit for drawing a destination candidate estimated by the destination estimating unit in a form different from an icon of a non-destination candidate; and an information display unit for causing the icon drawn by the drawing decision changing unit to be displayed.

### TECHNICAL FIELD

The present invention relates to a navigation system mounted in a vehicle for making various guidance, and particularly to a technique of distinguishing an estimated destination from others.

### BACKGROUND ART

As a navigation system, Patent Document 1, for example, discloses an information providing apparatus capable of automatically showing to a user information about a route which is estimated that the user will move along from now on from the present position of the user.

In the information providing apparatus, a position information acquiring unit captures information about the present position of a user, and a range setting unit sets an information acquisition area where the information is to be captured from the present position of the user. Then, the information acquiring unit captures target associated information from an information database and extracts from the target associated information the information contained in the information acquisition area set by the range setting unit, and an information presentation unit presents it to the user.

### PRIOR ART DOCUMENT

### Patent Document

Patent Document 1: Japanese Patent Laid-Open No. 2004-38871.

The information providing apparatus disclosed in the foregoing Patent Document 1 has a problem in that it is difficult for the user to decide whether the information presented is newly displayed information through the information acquisition or an existing display. In addition, it has a problem in that when there are not any facilities the user desires in the information acquisition area, but when they are outside the information acquisition area, only icons of facilities associated with a route along which the user is expected to move from now on are displayed so that the user cannot confirm ordinary icons and cannot get the information such as about desired facilities.

The present invention is implemented to solve the foregoing problems. Therefore it is an object of the present invention to provide a navigation system that can facilitate discrimination between the icons of facilities associated with the route along which the user is expected to move from now on and the ordinary icons.

### DISCLOSURE OF THE INVENTION

A navigation system in accordance with the present invention comprises: a destination estimating unit for acquiring information about a driving history and for estimating a destination from the information about the driving history acquired; a drawing decision changing unit for drawing a destination candidate estimated by the destination estimating unit in a form different from an icon of a non-destination candidate; and an information display unit for causing the icon drawn by the drawing decision changing unit to be displayed.

According to the navigation system in accordance with the present invention, since it is configured in such a manner as to draw and display the estimated destination candidate in a form different from the icon of the non-destination candidate, it can heighten the visibility of a user. As a result, the user can easily discriminate from ordinary icons the icon of the facility associated with the route along which the user is expected to move from now on.

### BRIEF DESCRIPTION OF THE DRAWINGS

FIG. 1 is a block diagram showing a configuration of a navigation system of an embodiment 1 in accordance with the present invention;

FIG. 2 is a block diagram showing a functional configuration of the control unit constituting the navigation system of the embodiment 1 in accordance with the present invention;

FIG. 3 is a flowchart showing processing of displaying a straight line from a start of driving to a destination candidate estimated or to a destination candidate in the navigation system of the embodiment 1 in accordance with the present invention;

FIG. 4 is a diagram showing an example of facility icons displayed on the screen in the navigation system of the embodiment 1 in accordance with the present invention;

FIG. 5 is a diagram showing an example of facility icons having various detailed information about facilities at an estimated destination candidate to be displayed on the screen in the navigation system of the embodiment 1 in accordance with the present invention;

FIG. 6 is a diagram showing an example of connecting the present location to destination candidates with straight lines and displaying them in the navigation system of the embodiment 1 in accordance with the present invention;

FIG. 7 is a diagram showing an example of displaying a plurality of icons superimposed in the navigation system of the embodiment 1 in accordance with the present invention;

FIG. 8 is a block diagram showing a configuration of a navigation system of an embodiment 2 in accordance with the present invention;

FIG. 9 is a block diagram showing a functional configuration of the control unit constituting the navigation system of the embodiment 2 in accordance with the present invention; and

FIG. 10 is a flowchart showing processing of estimating a destination by using voice recognition in the navigation system of the embodiment 2 in accordance with the present invention.

### EMBODIMENTS FOR CARRYING OUT THE INVENTION

The best mode for carrying out the invention will now be described with reference to the accompanying drawings.

### Embodiment 1

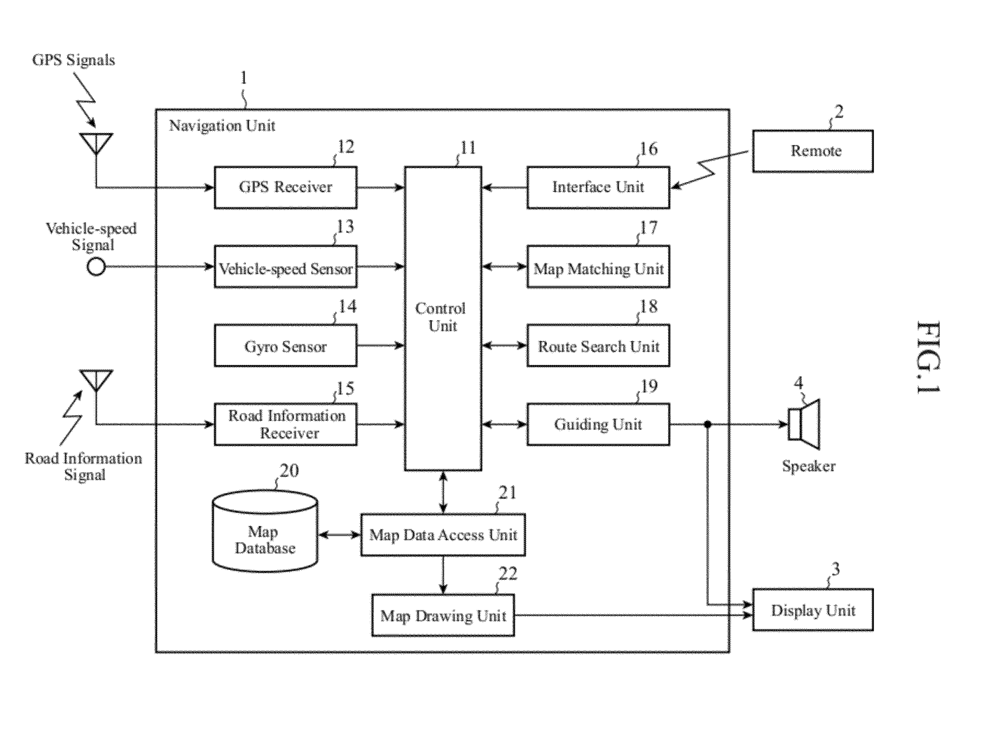

FIG. 1 is a block diagram showing a configuration of the navigation system of the embodiment 1 in accordance with the present invention. The navigation system comprises a navigation unit 1, a remote control (abbreviated to “remote” from now on) 2, a display unit 3 and a speaker 4.

The navigation unit 1 controls the whole navigation system. Details of the navigation unit 1 will be described later.

The remote 2 is used for a user to give the navigation system various instructions such as causing the display unit 3 to scroll, inputting a destination or a spot along the route at a route search, or responding to a message prompting an operation, which is output from the display unit 3 or speaker 4. Incidentally, instead of the remote 2 or in combination with the remote 2, a touch screen can be provided for inputting various instructions by directly touching a touch sensor mounted on the screen of the display unit 3.

The display unit 3, which is composed of an LCD (Liquid Crystal Display), for example, displays a map, a vehicle position mark, a guide route and various other messages in response to a display signal delivered from the navigation unit 1. The speaker 4 outputs a guiding message in a voice in response to a voice signal delivered from the navigation unit 1 to give guidance in a voice.

Next, details of the navigation unit 1 will be described. The navigation unit 1 comprises a control unit 11, a GPS (Global Positioning System) receiver 12, a vehicle-speed sensor 13, a gyro sensor 14, a road information receiver 15, an interface unit 16, a map matching unit 17, a route search unit 18, a guiding unit 19, a map database 20, a map data access unit 21 and a map drawing unit 22.

The control unit 11, which is composed of a microcomputer, for example, controls the whole navigation unit 1. As for the foregoing interface unit 16, map matching unit 17, route search unit 18, guiding unit 19, map data access unit 21 and map drawing unit 22, they are implemented by application programs executed by the microcomputer. Details of the control unit 11 will be described later.

The GPS receiver 12 detects the present position of a vehicle (not shown), in which the navigation system is mounted, from GPS signals received from GPS satellites via an antenna. The present position data, which indicates the present position of the vehicle detected by the GPS receiver 12, is delivered to the control unit 11.

According to the vehicle-speed signal delivered from the vehicle, the vehicle-speed sensor 13 detects the travel speed of the vehicle. The speed data indicating the travel speed of the vehicle detected with the vehicle-speed sensor 13 is delivered to the control unit 11. The gyro sensor 14 detects the direction of travel of the vehicle. The direction data indicating the direction of travel of the vehicle, which is detected with the gyro sensor 14, is delivered to the control unit 11.

The road information receiver 15 receives a road information signal transmitted from the Vehicle Information and Communication System, for example. The road information signal received by the road information receiver 15 is delivered to the control unit 11. According to the road information (such as traffic jam information and passable or impassable information) indicated by the road information signal delivered from the road information received 15 at regular intervals, the control unit 11 creates a message indicating a traffic jam of a road, for example, and causes the display unit 3 to display on the screen and the speaker 4 to output in a voice.

The interface unit 16 receives an instruction delivered from the remote 2 or generated through an operation of a control panel not shown and sends it to the control unit 11. In response to the instruction, the control unit 11 executes processing for carrying out scrolling of the screen, a facility search, route search or guidance, for example.

The map matching unit 17 locates the vehicle position indicated by the present position data delivered from the control unit 11 on the map which is a representation of the map data read from the map database 20 via the map data access unit 21 and control unit 11, and executes the processing of forming the vehicle position mark on the map. The processing result of the map matching unit 17 is delivered to the map drawing unit 22 via the control unit 11 and map data access unit 21.

The route search unit 18 searches for a route from the present position of the vehicle represented by the present position data delivered from control unit 11 to the destination indicated by the instruction delivered from the remote 2 or a control panel not shown via the interface unit 16 and control unit 11 according to the map data acquired from the map database 20 via the map data access unit 21 and control unit 11. The route searched by the route search unit 18 is delivered to the guiding unit 19 via the control unit 11 and to the map drawing unit 22 via the control unit 11 and map data access unit 21.

The guiding unit 19 creates, from the map data read from the map database 20 via the map data access unit 21 and control unit 11, a guiding map and a guiding message for leading the vehicle when it travels along the route the route search unit 18 searches for, and delivers them to the display unit 3 and speaker 4, respectively. This causes the display unit 3 to display the guiding map and the speaker 4 to produce the guiding message in a voice.

The map database 20 stores various data relating to the map such as road data and facility data as the map data. The map data stored in the map database 20 is read by the map data access unit 21. The map data access unit 21 reads out the map data stored in the map database 20 in response to an instruction from the control unit 11 and delivers to the control unit 11 and map drawing unit 22.

According to the map data delivered from the map data access unit 21, the map drawing unit 22 creates drawing data for causing the display unit 3 to display the map and the like. The drawing data created by the map drawing unit 22 is delivered to the display unit 3 as the display signal. This causes the display unit 3 to display on its screen the map, vehicle position mark, guide route, and other various messages.

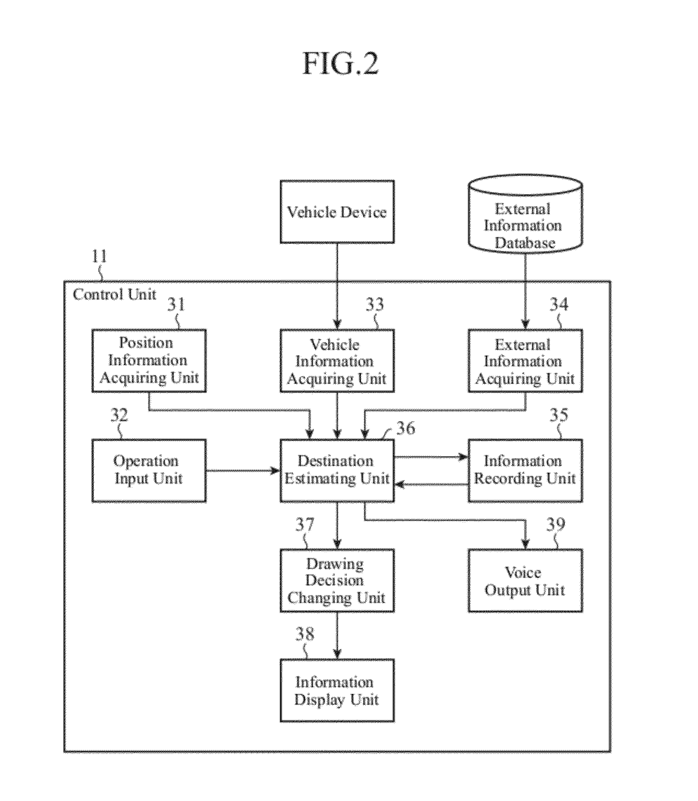

Next, details of the control unit 11 will be described. FIG. 2 is a block diagram showing a functional configuration of the control unit 11, which shows only a portion associated with the present invention. The control unit 11 comprises a position information acquiring unit 31, an operation input unit 32, a vehicle information acquiring unit 33, an external information acquiring unit 34, an information recording unit 35, a destination estimating unit 36, a drawing decision changing unit 37, an information display unit 38 and a voice output unit 39.

The position information acquiring unit 31 captures the present position data from the GPS receiver 12. In addition, the position information acquiring unit 31 receives the speed data from the vehicle-speed sensor 13 and the direction data from the gyro sensor 14, detects the present position of the vehicle using dead reckoning based on the speed data and direction data, and creates the present position data. This enables the navigation system to always detect the right present position of the vehicle because it can detect it by means of the dead reckoning even if the GPS receiver 12 cannot detect the present position of the vehicle because the vehicle enters a tunnel or a gap between high-rise buildings, for example. The present position data acquired or created by the position information acquiring unit 31 is delivered to the destination estimating unit 36.

The operation input unit 32, receiving the instruction delivered from the interface unit 16 in response to the operation of the remote 2, sends it to the destination estimating unit 36.

The vehicle information acquiring unit 33 acquires from the vehicle on which the navigation system is mounted the vehicle information such as fuel remaining (remaining battery life in the case of an electric vehicle), the presence or absence of lighting of a warning light, remaining battery life, the number of passengers, and average fuel efficiency, and transmits it to the destination estimating unit 36.

The external information acquiring unit 34 captures, from an external information database, external information such as weather information, information on bargains, price information of gasoline stations and coupon information of restaurants at regular intervals by communication, for example, and transmits it to the destination estimating unit 36.

The information recording unit 35 stores all sorts of information written by the destination estimating unit 36 such as driving history information, traffic jam information, vehicle information and road information. The driving history information includes ordinary traveling states (speed, roads or traveling histories) of a driver. The information stored in the information recording unit 35 is read out by the destination estimating unit 36. Incidentally, as for the information stored in the information recording unit 35, it can be configured in such a manner that it is acquired from the outside by communication or from a recording medium such as a USB memory.

Besides, the information recording unit 35 stores an operation history in addition to the information stored in the navigation system of the embodiment 1. The operation history is used as one of the decision materials for estimating a destination.

The destination estimating unit 36 estimates the destination of the vehicle from the information about the driving history, or more specifically, from at least one of the present position data delivered from the position information acquiring unit 31, instruction delivered from the operation input unit 32, vehicle information delivered from the vehicle information acquiring unit 33, external information delivered from the external information acquiring unit 34 and all sorts of information read out of the information recording unit 35. As for the estimation of the destination by the destination estimating unit 36, identification information (such as a driver, passenger, time and date, a day of the week or season) can also be used. The destination data indicating the destination estimated by the destination estimating unit 36 is delivered to the drawing decision changing unit 37 and voice output unit 39.

The drawing decision changing unit 37 alters facility icons in such a manner as to highlight a facility icon, at which the driver is very likely to stop at the destination estimated, that is, at the destination indicated by the destination data delivered from the destination estimating unit 36 in order to distinguish it from other ordinary facility icons, or as to non-highlight the other ordinary facility icons. The highlighting or non-highlighting can be carried out by varying a feature such as the size of the facility icon, a state with or without color, color strength or transparency of the icon display. The facility data representing the facility icon altered by the drawing decision changing unit 37 is delivered to the information display unit 38.

The information display unit 38 creates the display data for displaying the facility indicated by the facility data delivered from the drawing decision changing unit 37, and sends to the map drawing unit 22 via the map data access unit 21. According to the display data delivered from the map data access unit 21, the map drawing unit 22 creates the drawing data for causing the display unit 3 to display a map including the facility icon altered by the drawing decision changing unit 37, and sends to the display unit 3 as the display signal. Thus, the display unit 3 displays on its screen the map including the facility icon altered by the drawing decision changing unit 37.

The voice output unit 39 creates the voice data for outputting in a voice the destination indicated by the destination data delivered from the destination estimating unit 36, and sends to the guiding unit 19. The guiding unit 19 creates a guiding message indicating the destination from the voice data from the voice output unit 39 and sends to the speaker 4. Thus, the speaker 4 outputs the destination in a voice as a guiding message. As a result, the user can recognize the destination without watching the screen during driving.

Next, the operation of the navigation system of the embodiment 1 in accordance with the present invention with the foregoing configuration will be described. First, general operation of the navigation system will be described. When the navigation system is turned on, the present position data and map data are acquired. More specifically, the control unit 11 sends to the map matching unit 17 the present position data calculated from the present position data acquired from the GPS receiver 12 or calculated by the dead reckoning.

The map matching unit 17 reads out the map data from the map database 20 via the map data access unit 21 and control unit 11, and carries out matching processing of superimposing the vehicle position mark on the position corresponding to the present position data received from the control unit 11. The map data passing through the matching processing is delivered to the map drawing unit 22 via the control unit 11 and map data access unit 21. The map drawing unit 22 creates the drawing data from the map data delivered from the map matching unit 17, and sends to the display unit 3 as the display signal. Thus, the display unit 3 displays a map with the present position of the vehicle being placed at its center.

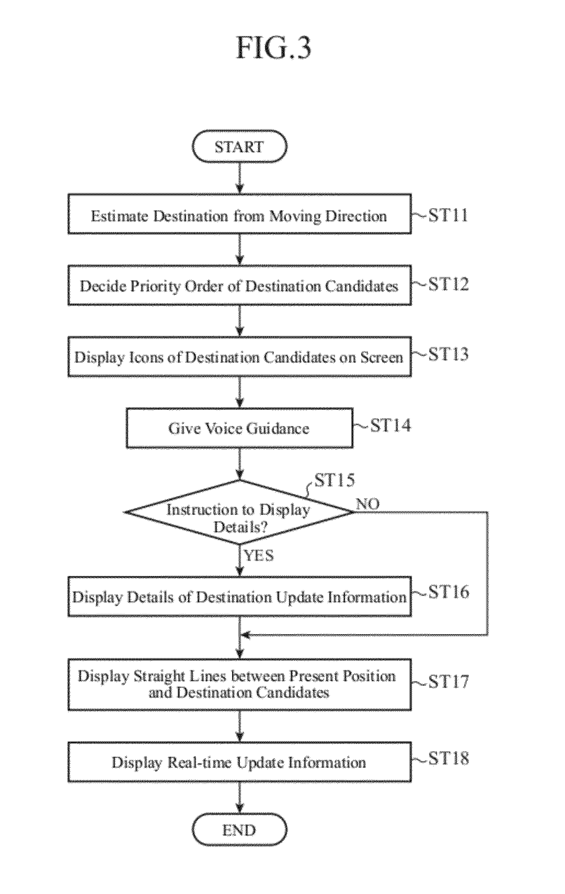

Next, the processing from a start of driving to the display of a destination candidate estimated or of the straight line to the destination candidate will be described with reference to the flowchart shown in FIG. 3.

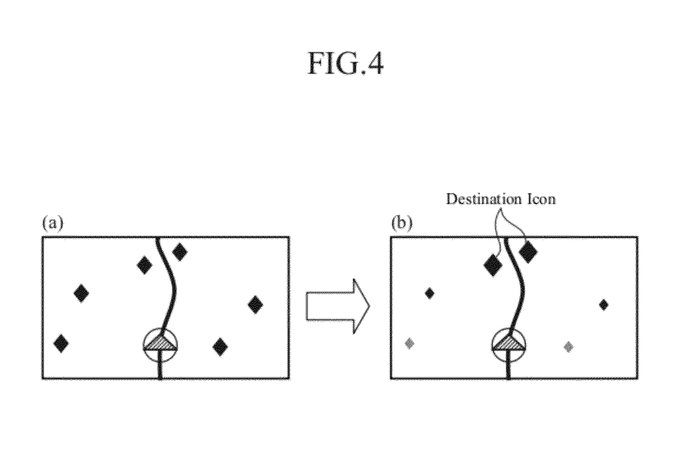

When driving is started, a road, the vehicle position on the road and facility icons around the road are displayed as shown in FIG. 4(a). When the vehicle with the navigation system mounted therein moves in this state, the destination is estimated from the direction of travel, first (step ST11). More specifically, when the vehicle runs some distance, the estimation of the destination is made from the information about the driving history. To be concrete, the destination estimating unit 36 estimates the direction of travel from the transition state of the present position data delivered from the position information acquiring unit 31, and estimates the destination from the direction of travel estimated and from the various information (such as the driving history, traffic jam information, vehicle information and road information) acquired from the information recording unit 35. The destination data indicating the destination candidate estimated by the destination estimating unit 36 is sent to the drawing decision changing unit 37.

Next, a priority decision of the destination candidates is made (step ST12). More specifically, when a plurality of destination candidates are estimated at step ST11, the destination estimating unit 36 gives priority to the destination candidates in ascending order of the distance or in descending order of the frequency of appearance. The priority given by the destination estimating unit 36 is delivered to the drawing decision changing unit 37.

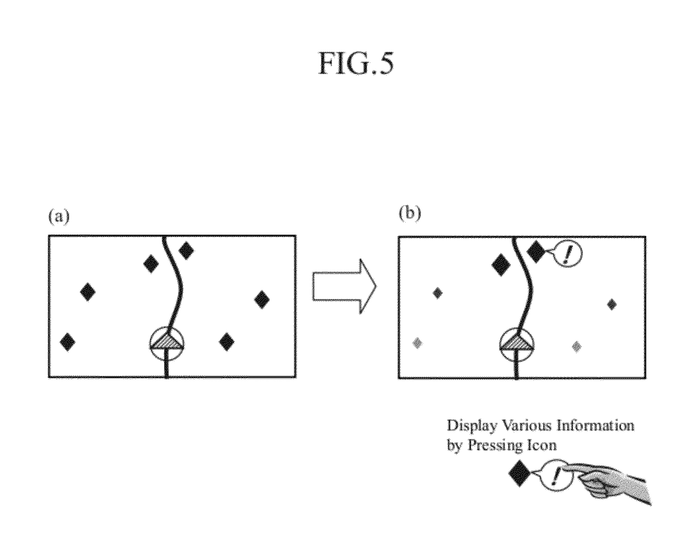

Next, an icon of a destination candidate is displayed on the screen (step ST13). More specifically, the drawing decision changing unit 37 alters the size of the facility icon, state with or without color, color strength, or transparency of icon display, for example, so as to highlight a facility icon of the destination estimated, that is, of the destination indicated by the destination data delivered from the destination estimating unit 36 in order to distinguish it from the other ordinary facility icons, or so as to non-highlight the other ordinary facility icons. FIG. 4(b) shows an example of highlighting facility icons at the destination candidate with their size being altered. In this case, when the destination candidate has detailed facility information, a facility icon at the destination candidate is displayed with “!” as shown in FIG. 5(b). Thus, the user can recognize at a glance whether the destination candidate estimated has detailed facility information or not.

Next, voice guidance is carried out (step ST14). More specifically, the voice output unit 39 produces voice guidance indicating that the destination candidate estimated by the destination estimating unit 36 is displayed. More specifically, the voice output unit 39 creates the voice data for outputting in a voice the destination indicated by the destination data delivered from the destination estimating unit 36, and sends to the guiding unit 19. The guiding unit 19 creates a guiding message indicating the destination from the voice data and sends to the speaker 4. Thus, the speaker 4 outputs the destination in a voice as a guiding message. As a result, the user can recognize the destination without watching the screen during driving.

Next, a check is done whether an instruction to display the details is given or not (step ST15). More specifically, as shown in FIG. 5(b), for example, when a facility icon at the destination candidate has “!” attached thereto for indicating that it has the detailed candidate information, a check is done whether the facility icon has been pressed or not.

At step ST15, if a decision is made that the instruction is given to display the details (“YES” at step ST15), a destination update information detail display is carried out (step ST16). More specifically, when the destination estimated by the destination estimating unit 36 has the detailed information or update information, the drawing decision changing unit 37 adds “!” indicating that to the facility icon at the destination candidate and draws it. In this state, when the user presses “!”, the detailed information about the facility indicated by the facility icon is displayed. At step ST15, if a decision is made that no instruction to display the details is given (“NO” at step ST15), the processing at step ST16 is skipped. The processing enables the user to perceive intuitively that the detailed update information is provided, and to cause the various detailed information to be displayed easily by pushing the icon.

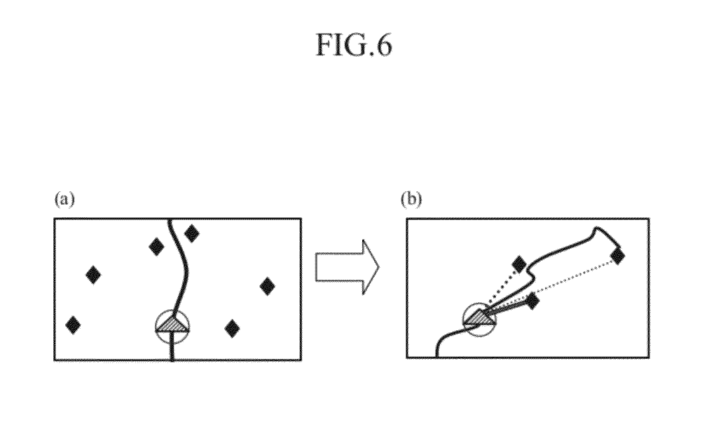

Next, the present location and destination candidates are displayed together with straight lines connecting between them (step ST17). More specifically, the drawing decision changing unit 37 creates the drawing data for drawing the straight lines connecting the destination candidates estimated by the destination estimating unit 36 with the present location, and sends the drawing data to the display unit 3 as the display signal. Thus, as shown in FIG. 6(b), the display unit 3 displays on its screen a map including the straight lines connecting the facility icons, to which the drawing decision changing unit 37 alters, with the present position of the vehicle. Accordingly, the user can easily learn the direction of the destination estimated.

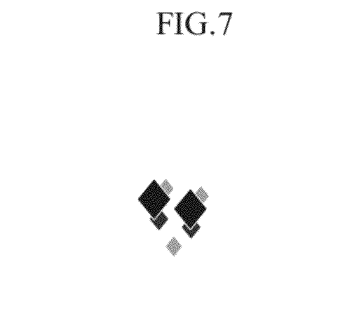

Incidentally, a configuration is also possible in which the destination estimating unit 36 gives priority to the destination candidates in the ascending order of the distance or in the descending order of the frequency of appearance, and the drawing decision changing unit 37 changes at least one of the type, thickness, color and being displayed or not of the straight lines in accordance with the priority given by the destination estimating unit 36. Alternatively, a configuration is also possible which gives priority to the facility icons at the destination candidate in accordance with the frequency or possibility of appearance, and displays icons on the display unit 3 in such a manner as to place stronger emphasis upon icons with higher priority as shown in FIG. 7, and to draw, when the facility icons are superimposed, the icons with higher priority to be placed on the nearer side.

Next, a real-time update information display is executed (step ST18). More specifically, the drawing decision changing unit 37 updates an estimate of the destination at regular intervals in accordance with the onward movement of the vehicle position. After that, the processing ends.

As described above, according to the navigation system of the embodiment 1 in accordance with the present invention, it causes the estimated destination candidate to be displayed in a manner different from icons other than the destination candidates, thereby being able to increase the visibility of a user. As a result, the user can discriminate the icons of facilities associated with the route along which the user is expected to move from now on from ordinary icons with ease.

Incidentally, a configuration is also possible which enables a user to set the destination by clicking the icon of the destination candidate estimated as described above. Alternatively, a configuration is also possible which enables a user to make a call to the destination or make a reservation via a net from a submenu with a similar operation.

### Embodiment 2

The navigation system of an embodiment 2 in accordance with the present invention is configured in such a manner as to estimate a destination using contents of a voice uttered in the vehicle in addition to the driving history used for estimating the destination candidates in the navigation system of the embodiment 1 described above. Incidentally, the following description will be made, centering on portions different from the navigation system of the embodiment 1.

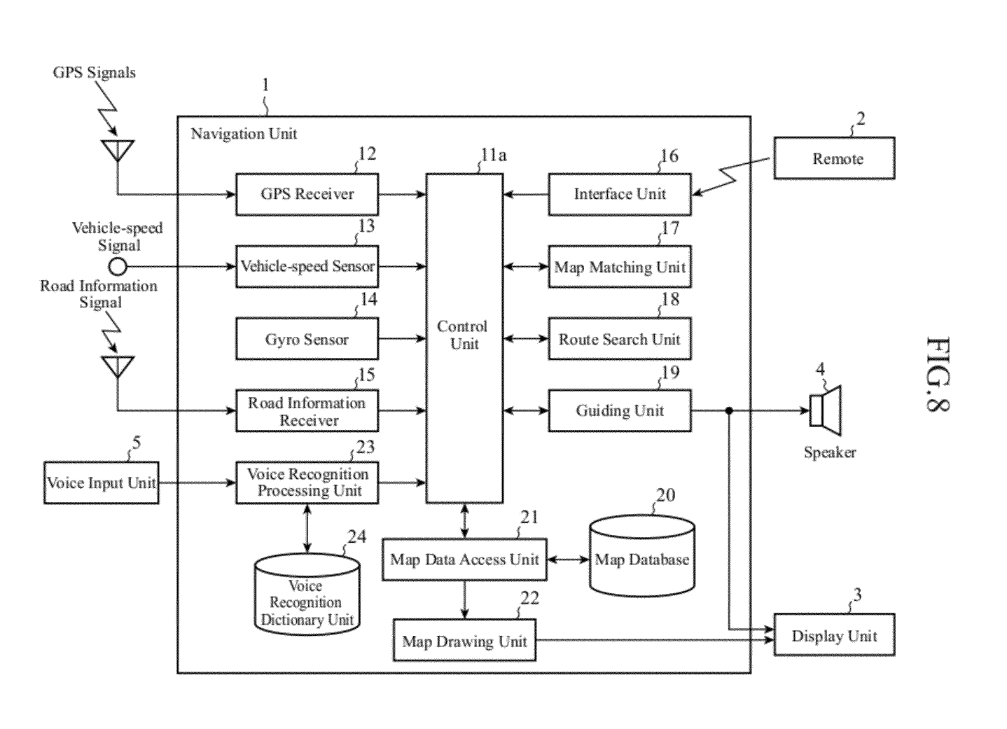

FIG. 8 is a block diagram showing a configuration of the navigation system of the embodiment 2 in accordance with the present invention. The navigation system comprises a voice input unit 5 in addition to the configuration of the navigation system of the embodiment 1 as shown in FIG. 1, and a voice recognition processing unit 23 and a voice recognition dictionary unit 24 are added to the navigation unit 1, and the control unit 11 in the navigation unit 1 is modified to the control unit 11a.

The voice input unit 5, which consists of a microphone, for example, creates a voice signal by converting contents of a conversation among passengers in the vehicle to an electric signal, and sends it to the voice recognition processing unit 23 as voice information.

The voice recognition processing unit 23 carries out voice recognition by comparing the voice information created from the voice signal sent from the voice input unit 5 with the voice information of the voice recognition dictionary stored in the voice recognition dictionary unit 24. A word recognized by the voice recognition processing in the voice recognition processing unit 23 is delivered to the control unit 11a.

The voice recognition dictionary unit 24 stores the voice recognition dictionary used for the voice recognition processing. The voice recognition dictionary describes correspondence between the voice information and recognized words. The voice recognition dictionary stored in the voice recognition dictionary unit 24 is referred to by the voice recognition processing unit 23 as described above.

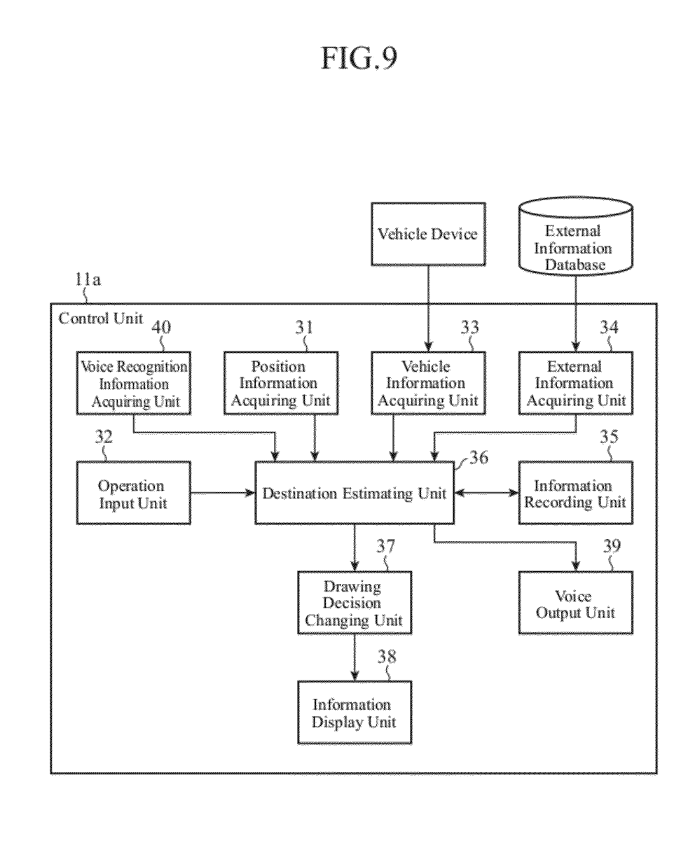

Next, details of the control unit 11a will be described. FIG. 9 is a block diagram showing a functional configuration of the control unit 11a. The control unit 11a is configured by adding a voice recognition information acquiring unit 40 to the control unit 11 in the navigation unit 1 of the navigation system of the embodiment 1 shown in FIG. 2.

The voice recognition information acquiring unit 40 acquires a facility name or place-name obtained through the voice recognition processing in the voice recognition processing unit 23, and sends it to the destination estimating unit 36.

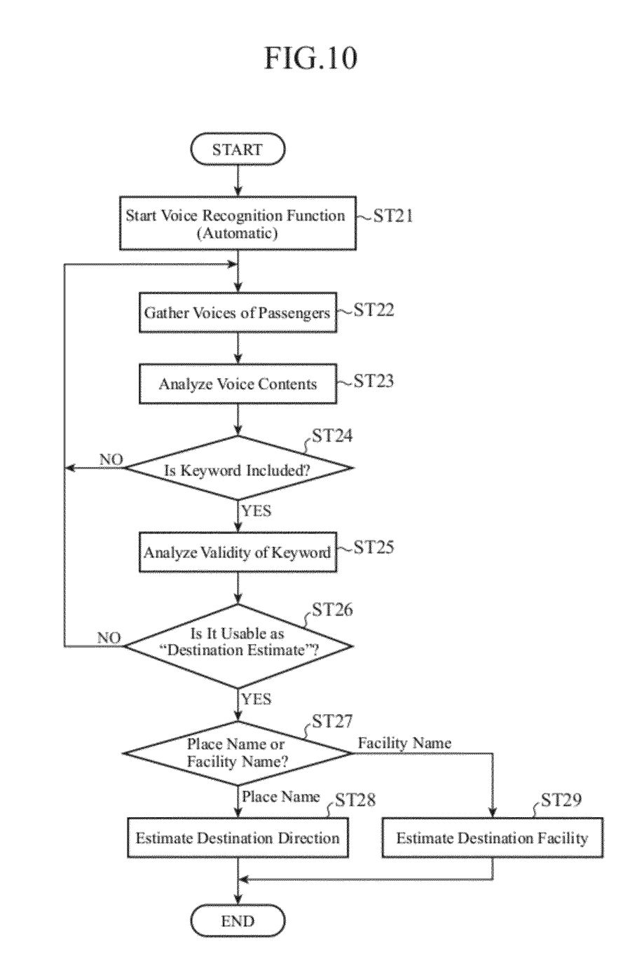

Next, the operation of the navigation system of the embodiment 2 in accordance with the present invention with the foregoing configuration will be described with reference to the flowchart shown in FIG. 10, centering on the estimation processing that estimates a destination from the voice recognition. The estimation processing is executed instead of the step ST11 of the processing shown in FIG. 3.

In the estimation processing, the voice recognition function is started, first (step ST21). The voice recognition function is automatically started in response to a start of the engine of the vehicle. Next, voices of passengers are gathered (step ST22). More specifically, the voice input unit 5 creates the voice signal by converting the conversation contents in the vehicle to the electric signal, and delivers it to the voice recognition processing unit 23 as the voice information.

Next, the voice contents are analyzed (step ST23). More specifically, the voice recognition processing unit 23 carries out voice recognition by comparing the voice information represented by the voice signal received from the voice input unit 5 with the voice information in the voice recognition dictionary stored in the voice recognition dictionary unit 24, and delivers the word acquired by the voice recognition to the control unit 11a.

Next, a check is done whether a keyword is captured or not (step ST24). More specifically, the control unit 11a checks whether the word delivered from the voice recognition processing unit 23 includes a keyword such as a place-name, facility name or facility name alternative word. Here, the term “facility name alternative word” refers to the following. For example, “I am hungry” is a facility alternative word of a “surrounding facility that serves a meal” and “I have a stomachache” is a facility alternative word of a “surrounding hospital”.

If a decision is made at this step ST24 that no keyword is captured, the sequence returns to step ST22 to repeat the processing described above. In contrast, if a decision is made at this step ST24 that a keyword is captured, then validity analysis of the keyword is made (step ST25). In the validity analysis, for example, a decision is made from the present location or the present time as to whether the keyword is appropriate as a destination candidate estimated, whether it is inconsistent (such as opposite in the direction) with the destination candidate that has already been decided as appropriate or not, and whether it is uttered repeatedly (decided as valid when repeated by a prescribed number of times or more).

Next, a check is done as to whether the keyword can be handled as a “destination estimate” or not (step ST26). More specifically, as for the keyword such as a place-name or facility name, which is made appropriate in the validity analysis of the keyword at step ST25, a check is done as to whether it can be handled as a destination estimate. If a decision is made at this step ST26 that the keyword cannot be handled as a “destination estimate”, the sequence returns to step ST22 and the processing described above is repeated.

On the other hand, if a decision is made at step ST26 that the keyword can be handled as a “destination estimate”, a check is done as to whether the keyword is a place-name or facility name (step ST27). If a decision is made at this step ST27 that it is a place-name, an estimate of the direction of the destination is made (step ST28). More specifically, the destination estimating unit 36 estimates the direction of movement from the place-name delivered from the voice recognition information acquiring unit 40, and estimates a destination from the direction of movement estimated and from the various information (driving history information, traffic jam information, vehicle information, road information and the like) acquired from the information recording unit 35. The destination data indicating the destination candidate estimated by the destination estimating unit 36 is delivered to the drawing decision changing unit 37. After that, the estimation processing ends.

On the other hand, if a decision is made at this step ST27 that the keyword is a facility name, an estimate of the destination facility is made (step ST29). More specifically, the destination estimating unit 36 estimates the direction of movement from the facility name delivered from the voice recognition information acquiring unit 40, and estimates the destination from the direction of movement estimated and from the various information (driving history information, traffic jam information, vehicle information, road information and the like) acquired from the information recording unit 35. The destination data indicating the destination candidate estimated by the destination estimating unit 36 is delivered to the drawing decision changing unit 37. After that, the estimation processing ends.

As described above, according to the navigation system of the embodiment 2 in accordance with the present invention, since it is configured in such a manner as to estimate the destination using the contents of a voice uttered in the vehicle in addition to the driving history, it can improve the estimation accuracy. Besides, since it automatically starts the voice recognition function in response to a start of the engine of the vehicle, and estimates the place-name or facility name of the destination from the conversation contents in the vehicle, it is not necessary for the user to give utterance for deciding the destination.

Incidentally, the navigation system of the embodiment 2 described above can be configured in such a manner that when the same word is uttered repeatedly any number of times (a prescribed number of times or more) in the conversation of the user, it gives a higher priority to the facility information corresponding to the word, and displays its icon differentiating it from the other icons. According to the configuration, the user can learn at a glance that a higher priority is given to the facility information corresponding to the word which is repeated several times.

In addition, as for the destination candidate estimated by the voice recognition, since the facility information estimated varies when the conversation contents vary, a configuration is possible which erases old facility information that has been estimated and adds new facility information when the conversation contents vary. Incidentally, although a configuration is possible which exchanges the old and new facility information all at once, a configuration is also possible which displays the old facility information and new facility information simultaneously for a while and erases a piece of information in accordance with the state of progress of conversation. In addition, a configuration is also possible which distinguishes between icons of the new and old facility information, and displays them differentiating between them. According to the configuration, it can cope with the conversation contents that vary moment by moment.

In addition, when the facility information at the destination estimated using the history information of the user agrees with the facility information at the destination estimated by the voice recognition, either of the icons can be used. As to which icon is to be given priority, the user can set freely. Besides, a configuration is also possible which makes completely different the icons of the facility information which agree with each other, thereby differentiating the icons. According to the configuration, the user can freely assign priority to the icons.

Furthermore, although the navigation system of the embodiment 2 described above is configured in such a manner as to carry out the voice recognition processing within itself, a configuration is also possible which transmits the voice information input from the voice input unit 5 to a server via a network, causes the server to execute the voice recognition processing and to return a word acquired by the voice recognition processing to the navigation system, and changes the display of the facility icons on the navigation system using the word received from the server. According to the configuration, since the voice recognition processing is executed by the server, the accuracy of the voice recognition can be improved. As a result, it can improve the estimation accuracy of the destination.

### INDUSTRIAL APPLICABILITY

The present invention can be applied to a car navigation system or the like which estimates a destination and displays a facility estimated while distinguishing it from the others.

1. A navigation system comprising:
a destination estimating unit for acquiring information about a driving history and for estimating a destination from the information about the driving history acquired;
a drawing decision changing unit for drawing a destination candidate estimated by the destination estimating unit in a form different from an icon of a non-destination candidate;
an information display unit for causing the icon drawn by the drawing decision changing unit to be displayed; and
a voice recognition processing unit for recognizing a voice uttered, wherein
the destination estimating unit estimates a destination from the information about the driving history acquired and from a word recognized by the voice recognition processing unit.

2. The navigation system according to claim 1, wherein
the drawing decision changing unit differentiates at least one of size, a state with or without color, color strength and transparency of display of an icon of the destination candidate estimated by the destination estimating unit from the icon of the non-destination candidate, thereby highlighting the icon of the destination candidate or non-highlighting the icon of the non-destination candidate.

3. The navigation system according to claim 1, wherein
the destination estimating unit estimates the destination using information about the driving history including an everyday driving state of a driver, vehicle information and discrimination decision information.

4. The navigation system according to claim 1, wherein
the drawing decision changing unit draws, when the destination estimated by the destination estimating unit has update information, the icon of the destination candidate with a mark indicating that.

5. The navigation system according to claim 1, wherein
the drawing decision changing unit acquires, from outside at regular intervals, weather information, bargain information, price information of a gasoline station, bargain information including coupon information of a restaurant and road information including traffic jam information to the destination candidate, and draws them with the destination candidate estimated by the destination estimating unit.

6. The navigation system according to claim 1, further comprising:
a voice output unit for outputting, when the destination candidate estimated by the destination estimating unit is displayed, voice guidance for indicating that.

7. The navigation system according to claim 1, wherein
the drawing decision changing unit draws a straight line connecting the destination candidate estimated by the destination estimating unit with the present location.

8. The navigation system according to claim 1, wherein
the destination estimating unit gives priority to the destination candidates estimated in ascending order of a distance or in descending order of a frequency; and
the drawing decision changing unit draws the straight line while varying at least one of a type, thickness, color and display or not of the straight line in accordance with the priority given by the destination estimating unit.

9. The navigation system according to claim 1, wherein
the drawing decision changing unit, when a plurality of destination candidates are estimated by the destination estimating unit, gives priority to icons of the destination candidates in accordance with a frequency or probability, and draws an icon with higher priority with greater emphasis and draws, when the icons overlap, an icon with higher priority in a manner to come frontward.

10. (canceled)

11. The navigation system according to claim 1, wherein
the destination estimating unit assigns higher priority to the destination candidate corresponding to the word which is recognized by the voice recognition processing unit by a prescribed number of times or more.

12. The navigation system according to claim 1, wherein
the destination estimating unit, when a word recognized by the voice recognition processing unit varies, eliminates an old destination candidate estimated and adds the newly recognized word as a new destination candidate.

13. The navigation system according to claim 1, wherein
the drawing decision changing unit draws as the icon of the destination candidate an icon of the destination candidate estimated using a word recognized by the voice recognition processing unit or an icon of the destination candidate estimated using the information about the driving history.
